(19) United States
(12) Patent Application Publication
(10) Pub. No.: US 2017/0219451 A1
(43) Pub. Date: Aug. 3, 2017

(54) TEMPORAL DELAY DETERMINATION FOR CALIBRATION OF DISTRIBUTED SENSORS IN A MASS TRANSPORT NETWORK

(71) Applicant: International Business Machines Corporation, Armonk, NY (US)

(72) Inventors: Harsh Chaudhary, Briarcliff Manor, NY (US); Younghun Kim, White Plains, NY (US); Tarun Kumar, Mohegan Lake, NY (US); Rui Zhang, Ossining, NY (US)

(21) Appl. No.: 15/009,262

(22) Filed: Jan. 28, 2016

(51) Int. Cl. G01L 27/00; G01F 25/00

(52) U.S. Cl. CPC G01L 27/005; G01F 25/0007

(57) ABSTRACT

A method and system of calibrating uncalibrated sensors among sensors distributed along a pipeline network include designating a set of the sensors as upstream sensors based on their geopositions, and designating remaining ones of the sensors other than the set of the sensors as downstream sensors. The method also includes determining a temporal delay associated with each of the sensors. Calibrating the uncalibrated sensors is based on the corresponding temporal delay and on calibrated sensors among the sensors.

### BACKGROUND

The present invention relates to a mass transport network, and more specifically, to temporal delay determination for calibration of distributed sensors in a mass transport network.

Pipeline networks that transport water, natural gas, or other resources can traverse hundreds of miles at or above the surface. Sensors and other equipment may be located at regular or irregular intervals of the network (e.g., every 30-100 miles). A supervisory control and data acquisition (SCADA) system obtains data from and provides control to the remote sensors and equipment.

### SUMMARY

According to an embodiment of the present invention, a method of calibrating uncalibrated sensors among sensors distributed along a pipeline network includes designating a set of the sensors as upstream sensors based on their geopositions; designating remaining ones of the sensors other than the set of the sensors as downstream sensors; determining, using a processor, a temporal delay associated with each of the sensors; and calibrating, using the processor, the uncalibrated sensors based on the corresponding temporal delay and on calibrated sensors among the sensors.

According to another embodiment, a system to calibrate uncalibrated sensors among sensors distributed along a pipeline network includes a memory device configured to store geopositions of each of the sensors; and a processor configured to designate a set of the sensors as upstream sensors based on their geopositions, designate remaining ones of the sensors other than the set of the sensors as downstream sensors, determine a temporal delay associated with each of the sensors, and calibrate the uncalibrated sensors based on the corresponding temporal delay and on calibrated sensors among the sensors.

According to yet another embodiment, a computer program product for calibrating uncalibrated sensors among sensors distributed along a pipeline network comprises a computer readable storage medium having program instructions embodied therewith. The program instructions are executable by a processor to perform a method including designating a set of the sensors as upstream sensors based on their geopositions; designating remaining ones of the sensors other than the set of the sensors as downstream sensors; determining a temporal delay associated with each of the sensors; and calibrating the uncalibrated sensors based on the corresponding temporal delay and on calibrated sensors among the sensors.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a system that calibrates sensors in a pipeline network according to embodiments;

FIG. 2 shows an exemplary time-varying signal recorded by a sensor of pipeline network that is calibrated according to embodiments

FIG. 3 shows the exemplary pipeline network with upstream and downstream sensors delineated; and

FIG. 4 is a process flow of a method of calibrating sensors in a pipeline network according to embodiments.

### DETAILED DESCRIPTION

As noted above, a pipeline network includes distributed sensors that measure a property (e.g., pressure, flow rate) that facilitates monitoring the condition of the network. Each sensor includes a transducer to convert one type of energy (e.g., force) to another (e.g., voltage, current). This transducer output must then be calibrated to the physical quantity of interest. That is, for example, a given voltage value resulting from a measurement must be calibrated to the corresponding pressure. This mapping or calibration is essential to obtaining meaningful information from each sensor. Yet, only some of the sensors of a pipeline network may be calibrated. Further, calibration may need to be updated because of changes in the condition of the transducer due to wear and tear. In a perfect system with no temporal delays, a single snapshot of sensors values would be sufficient to calibrate the uncalibrated sensors based on the calibrated sensors according to known techniques such as regression analysis, generalized linear model, and non-linear kernel regression. However, in reality, calibration of the uncalibrated sensors is complicated by the differently delayed propagation time of the sensors. That is, a snapshot of sensor values at the SCADA system, for example, would actually correspond to different times at different sensors because of the different propagation delays associated with communication from each sensor to the SCADA or other collection system. Embodiments of the systems and methods detailed herein relate to determining the temporal delay associated with each sensor based on the mass conservation law. Once the temporal delay specific to each sensor is known, calibration of the uncalibrated sensors may be performed. As detailed below, for the time-varying data signal obtained by each sensor, a specific time window is identified such that the mass conservation law holds true. That is, the specific time window of each time-varying data signal (obtained by each sensor) that equates with the time window of every other time-varying data signal (obtained by every other sensor) is determined to identify the temporal delay of each sensor. Then, the calibrated sensors may be used to calibrate the uncalibrated sensors.

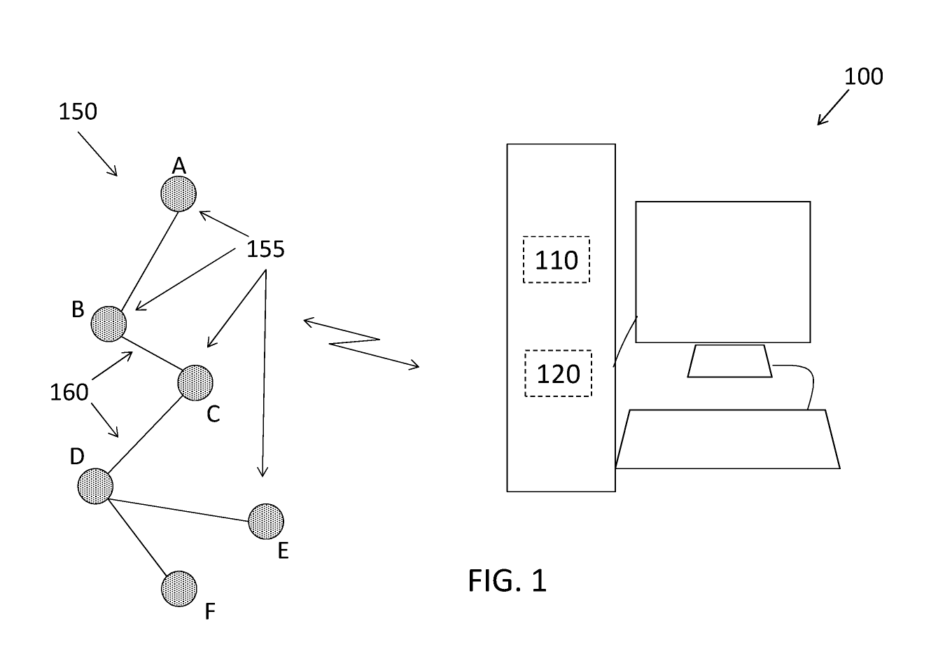

FIG. 1 is a block diagram of a system 100 that calibrates sensors 155 in a pipeline network 150 according to embodiments of the invention. The pipeline network 150 includes sensors 155 at known locations based on geopositioning. As noted above, the sensors 155 measure a physical quantity that may be specific to the type of the pipeline network 150. For example, when the pipeline network 150 is a natural gas pipeline, each of the sensors 155 measures pressure as a time-varying signal. As another example, when the pipeline network 150 transports water, each of the sensors 155 measures flow rate as the time-varying signal. The pipeline network 150 also includes pipe segments 160 that are interconnections between each pair of sensors 155. The exemplary pipeline network 150 in FIG. 1 includes exemplary sensors 155 A, B, C, D, E, and F. The system 100 includes one or more memory devices 110 and one or more processors 120. The system 100 includes additional known components such as, for example, an interface to receive the time-varying signal obtained by each of the sensors 155 of the physically connected network 150. The system 100 that calibrates the sensors 155 may be the SCADA system or a different system in communication with the sensors 155, the SCADA system, or both. The memory device 110 stores instructions implemented by the processor 120 to calibrate uncalibrated sensors 155 according to the embodiments detailed below. The memory device 110 may additionally store a local copy of the asset registry that includes the geopositions of the sensors 155, for example.

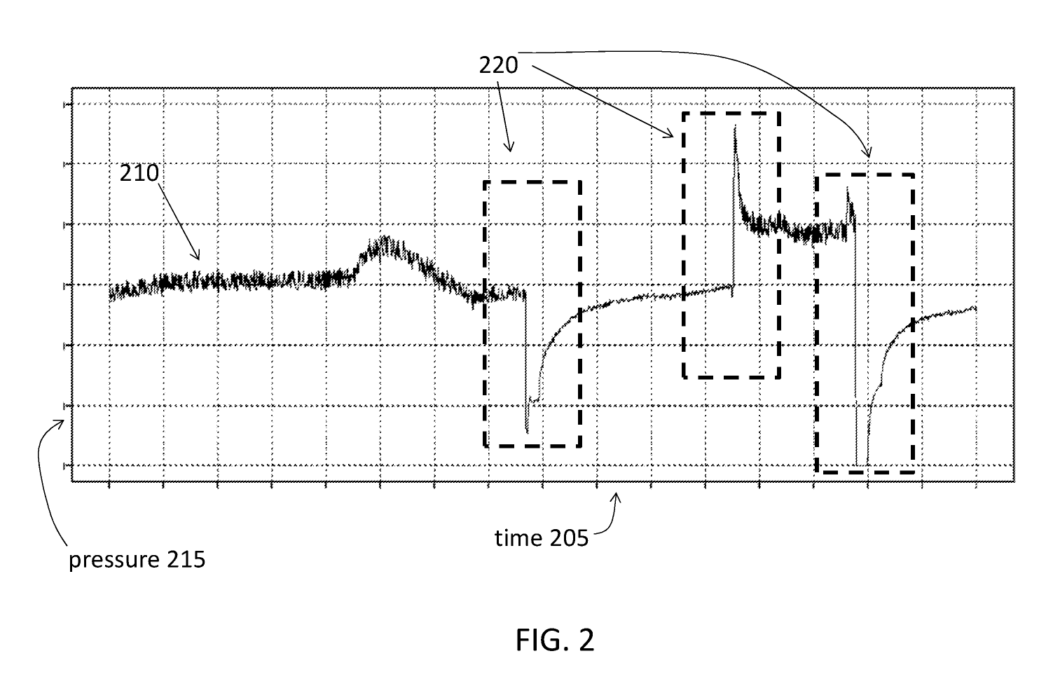

FIG. 2 shows an exemplary time-varying signal recorded by a sensor 155 of pipeline network 150 that is calibrated according to embodiments. The exemplary time-varying signal shown in FIG. 2 is a pressure signal 210 with time shown along axis 205 and pressure indicated along axis 215. Patterns 220 may be detected within the pressure signal 210 to learn information about the pipeline network 150. For example, in the exemplary gas network, compression stations may be located along the pipeline to increase pressure and, thus, facilitate movement of the gas. The increased pressure reaching each sensor 155 may be detected according to the associated pattern 220. The pattern 220 detection may be done by any number of known methods. As noted above, each of the sensors 155 that obtains and provides the time-varying signal like pressure signal 210 must be calibrated in order for meaningful information to be ascertained.

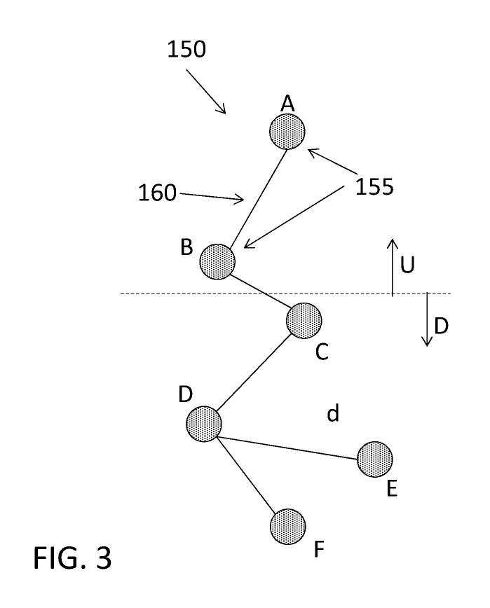

FIG. 3 shows the exemplary pipeline network 150 with a delineation indicated. The pipeline network 150 is shown with relative placement of the sensors 155 indicated by their respective geopositions. As shown in FIG. 2, the sensors 155 on one side of the delineation may be considered upstream sensors 155 (U) and the sensors 155 on the other side of the delineation may be considered downstream sensors 155 (D). The exemplary delineation shown in FIG. 2 may be moved anywhere along the pipeline network 150, and there is no requirement that the number of upstream sensors 155 must be the same as the number of downstream sensors 155, for example. However, the two sets of sensors 155 may not be mixed (e.g., sensor 155 D may not be designated as an upstream sensor 155 if sensor 155 C is designated as a downstream sensor 155). The mass conservation law applied to the pipeline network 150 may be represented as:

|Σ_{iεU} Σₜ_{ₛₜᵣₜ}_{+Δt}_{ᵢ}^{t}^{_{end}}^{+Δt}^{ᵢ}Qᵢ(t)−Σ_{iεD} Σₜ_{ₛₜᵣₜ}_{+Δt}_{ᵢ}^{t}^{_{end}}^{+Δt}^{ᵢ}Qᵢ(t)|ₙₒᵣₘ [EQ. 1]

For each sensor 155 i, the temporal delay value Δtᵢ is determined that minimizes EQ. 1 (i.e., makes the result of EQ. 1 less than a predetermined threshold value). Apriori knowledge is used to reduce the search space for Δtᵢ. Specifically, each Δtᵢ value must be between 0 and a predetermined maximum temporal delay value. Further, search space may be reduced based on knowledge about relative temporal delays among the sensors 155, according to observation of the time-varying signal obtained from each sensor 155 or the geopositions of the sensors 155.

In EQ. 1, U and D refer to the upstream and downstream sensors 155, respectively. The start time and end time, tₛₜᵣₜ and t_{end}, respectively, are fixed values for every sensor 155 i, but the delay Δtᵢ is specific to each sensor 155 i. Thus, the size of the time window (i.e., the duration of Q(t), the iso-thermal mass flow rate) is the same for every sensor 155 i but the placement of the time window (i.e., the specific subset of the time-varying signal) is specific to each sensor 155 i. The size of the time window (represented by the difference between tₛₜᵣₜ and t_{end}) is selected based on the maximum temporal delay expected between pairs of sensors 155 to ensure that the entire cycle of mass flow is captured. The iso-thermal mass flow rate is given by:

Qᵢ(t)=pᵢ(t)qᵢ(t) [EQ. 2]

In EQ. 2, p(t) and q(t) are pressure and flow rate, respectively. When the sensors 155 measure flow rate, as in a water pipeline network 150, for example, pi(t)=1. When the sensors 155 measure pressure, as in a gas pipeline network 150, for example, then flow rate, q(t), may be determined from pressure such that EQ. 2 is re-written:

Qᵢ(t)=pᵢ(t)(pᵤₚₛₜᵣₑₐₘ−pᵢ(t)) [EQ. 3]

The value of upstream pressure (pᵤₚₛₜᵣₑₐₘ) is estimated based on observation using one or more calibrated upstream sensors 155. To be clear, Q(t) will be an incorrect value for the uncalibrated sensors 155. However, while the value (specifically, the mapping from the transducer output to the physical property of interest) is incorrect for the uncalibrated sensors 155, the value is still proportional to changes in the property (e.g., incorrect pressure value will increase when pressure increases). Thus, EQ. 1 may be minimized (to a value below a predefined threshold) to determine the temporal delay Δt associated with every (calibrated and uncalibrated) sensor 155.

Once the correct temporal delay Δt associated with each sensor 155 is determined, a true snapshot of the pipeline network 150 may be obtained such that correlation based on the known techniques of regression analysis, generalized linear modeling, and non-linear kernel regression is accurate. As detailed below, according to an embodiment, the temporal delay Δt and already calibrated sensors 155 may be used to determine the proper calibration of the uncalibrated sensors 155 in accordance with the mass conservation law. According to an alternate embodiment, determination of temporal delay Δt and calibration of the uncalibrated sensors 155 may be done simultaneously, as further discussed below.

Based on the determination of the temporal delay Δt for each sensor 155 i as discussed above, the start and end times for each sensor 155 i are given by:

t_{s,i}=tₛₜᵣₜ+Δtᵢ [EQ. 4]

t_{e,i}=t_{end}+Δtᵢ [EQ. 5]

Then EQ. 1 may be re-written as:

|Σ_{iεU} Σₜ_{_{s,i}}^{t}^{_{e,i}}Qᵢ(t)−Σ_{iεD} Σₜ_{_{s,i}}^{t}^{_{e,i}}Qᵢ(t)|ₙₒᵣₘ [EQ. 6]

An affine calibration model may be represented as:

qᵢ=αᵢ\hat{q}ᵢ+βᵢ [EQ. 7]

pᵢ=aᵢ\hat{p}ᵢ+bᵢ [EQ. 8]

As EQs. 7 and 8 indicate, flow rate q and pressure p may be determined from measured flow rate \hat{q} and measured pressure \hat{p} according to linear functions with α and a representing slope, and b and β representing bias. The coefficients α, β, a, and b are determined for each of the uncalibrated sensors 155 j by determining the coefficients that minimize EQ. 6 (i.e., make the result of EQ. 6 less than a predetermined threshold value). For the calibrated sensors 155, p and q (and, thus, Q(t)) are already correct (the coefficients are known). As note above, in an alternate embodiment, the temporal delay Δt for every sensor 155 and the coefficients for the uncalibrated sensors 155, α, β, a, and b, may be found simultaneously using EQ. 1.

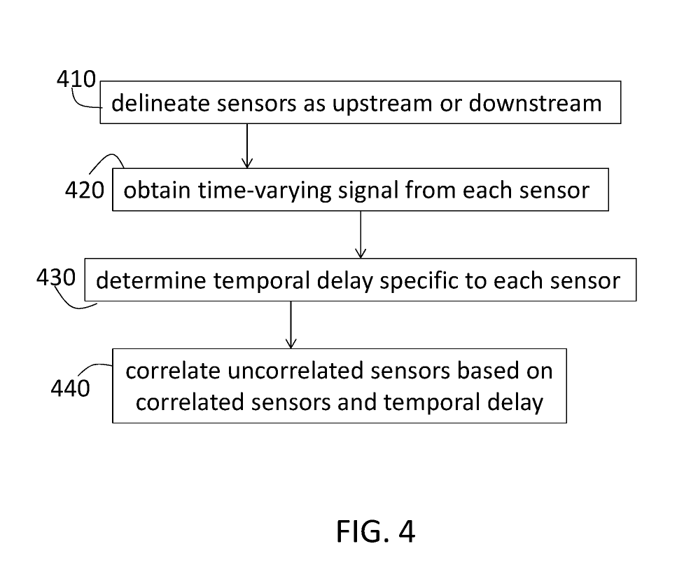

FIG. 4 is a process flow of a method of calibrating sensors 155 in a pipeline network 150 according to embodiments. At block 410, delineating sensors 155 as upstream and downstream sensors includes designating at least some of the sensors 155 as upstream and at least some of the sensors 155 as downstream. At block 420, obtaining a time-varying signal from each sensor 155 may include obtaining a signal indicating pressure or flow rate, for example. At block 430, determining a temporal delay specific to each sensor 155 refers to solving EQ. 1 for the Δt value specific to each sensor 155, as discussed above. At block 440, the processes include correlating uncorrelated sensors based on the correlated sensors 155 and temporal delay Δt determined at block 430. The correlating, at block 440, includes using the affine models represented by EQs. 7 and 8 and minimizing the coefficients shown in EQs. 7 and 8 in order to make the result of EQ. 6 nearly 0 (below a threshold value). EQ. 6 is examined based on the temporal delay determined at block 430. According to an alternate embodiment, the processes at blocks 430 and 440 may be combined. That is, the value of Δt for all the sensors 155 and the values of α, β, a, and b for the uncalibrated sensors 155 may all be found by minimizing EQ 1.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of calibrating uncalibrated sensors among sensors distributed along a pipeline network, the method comprising:
designating a set of the sensors as upstream sensors based on their geopositions;
designating remaining ones of the sensors other than the set of the sensors as downstream sensors;
determining, using a processor, a temporal delay associated with each of the sensors; and
calibrating, using the processor, the uncalibrated sensors based on the corresponding temporal delay and on calibrated sensors among the sensors.

2. The computer-implemented method according to claim 1, further comprising obtaining a time-varying signal from each of the sensors.

3. The computer-implemented method according to claim 2, wherein the determining the temporal delay includes isolating a subset of the time-varying signal associated with each of the sensors such that a duration of every subset is the same and a start time and an end time of every subset is determined for each of the sensors.

4. The computer-implemented method according to claim 2, wherein the determining the temporal delay includes solving an equation representing mass conservation law that is given by:

|Σ_{iεU} Σₜ_{ₛₜᵣₜ}_{+Δt}_{ᵢ}^{t}^{_{end}}^{+Δt}^{ᵢ}Qᵢ(t)−Σ_{iεD} Σₜ_{ₛₜᵣₜ}_{+Δt}_{ᵢ}^{t}^{_{end}}^{+Δt}^{ᵢ}Qᵢ(t)|ₙₒᵣₘ, where
U refers to the upstream sensors, D refers to the downstream sensors, tstrt and tend are start and end times, respectively, that are fixed for all the sensors, Δt is the temporal delay associated with each of the sensors, and Q(t) is iso-thermal mass flow rate obtained from the time-varying signal of each of the sensors.

5. The computer-implemented method according to claim 4, wherein the determining the temporal delay includes determining the Δt for each of the sensors that makes a result of the equation less than a threshold value.

6. The computer-implemented method according to claim 4, further comprising determining the iso-thermal mass flow rate for each of the sensors as:
Qᵢ(t)=pᵢ(t)qᵢ(t), where
p(t)=1 and q(t) is flow rate indicated by the time-varying signal based on the pipeline network transporting water, and determining the iso-thermal mass flow rate for each of the sensors as:
Qᵢ(t)=pᵢ(t)(pᵤₚₛₜᵣₑₐₘ−pᵢ(t)), where
p(t)=is pressure indicated by the time-varying signal based on the pipeline network transporting natural gas, and pᵤₚₛₜᵣₑₐₘ is an upstream pressure value determined based on monitoring the sensors.

7. The computer-implemented method according to claim 6, wherein the calibrating the uncalibrated sensors includes obtaining measured values of pressure \hat{p} and flow rate \hat{q} from the time-varying signal from each of the sensors and determining coefficients α, β, a, and b for each of the uncalibrated sensors that minimize the equation, given that:
qᵢ=αᵢ\hat{q}ᵢ+βᵢ, and
pᵢ=aᵢ\hat{p}ᵢ+bᵢ.

8. A system to calibrate uncalibrated sensors among sensors distributed along a pipeline network, the system comprising:
a memory device configured to store geopositions of each of the sensors; and
a processor configured to designate a set of the sensors as upstream sensors based on their geopositions, designate remaining ones of the sensors other than the set of the sensors as downstream sensors, determine a temporal delay associated with each of the sensors, and calibrate the uncalibrated sensors based on the corresponding temporal delay and on calibrated sensors among the sensors.

9. The system according to claim 8, further comprising an interface configured to receive a time-varying signal from each of the sensors.

10. The system according to claim 9, wherein the processor determines the temporal delay by isolating a subset of the time-varying signal associated with each of the sensors such that a duration of every subset is the same and a start time and an end time of every subset is determined for each of the sensors.

11. The system according to claim 9, wherein the processor determines the temporal delay by solving an equation representing mass conservation law that is given by:

|Σ_{iεU} Σₜ_{ₛₜᵣₜ}_{+Δt}_{ᵢ}^{t}^{_{end}}^{+Δt}^{ᵢ}Qᵢ(t)−Σ_{iεD} Σₜ_{ₛₜᵣₜ}_{+Δt}_{ᵢ}^{t}^{_{end}}^{+Δt}^{ᵢ}Qᵢ(t)|ₙₒᵣₘ, where
U refers to the upstream sensors, D refers to the downstream sensors, tstrt and tend are start and end times, respectively, that are fixed for all the sensors, Δt is the temporal delay associated with each of the sensors, and Q(t) is iso-thermal mass flow rate obtained from the time-varying signal of each of the sensors.

12. The system according to claim 11, wherein the processor determines the temporal delay by determining the Δt for each of the sensors that makes a result of the equation less than a threshold value.

13. The system according to claim 11, wherein the iso-thermal mass flow rate for each of the sensors is given by:
Qᵢ(t)=pᵢ(t)qᵢ(t), where
p(t)=1 and q(t) is flow rate indicated by the time-varying signal based on the pipeline network transporting water, and the iso-thermal mass flow rate for each of the sensors is given by:
Qᵢ(t)=pᵢ(t)(pᵤₚₛₜᵣₑₐₘ−pᵢ(t)), where
p(t)=is pressure indicated by the time-varying signal based on the pipeline network transporting natural gas, and pᵤₚₛₜᵣₑₐₘ is an upstream pressure value determined based on monitoring the sensors.

14. The system according to claim 13, wherein the processor calibrates the uncalibrated sensors by obtaining measured values of pressure \hat{p} and flow rate \hat{q} from the time-varying signal from each of the sensors and determining coefficients α, β, a, and b for each of the uncalibrated sensors that minimize the equation, given that:
qᵢ=αᵢ\hat{q}ᵢ+βᵢ, and
pᵢ=αᵢ\hat{p}ᵢ+bᵢ.

15. A computer program product for calibrating uncalibrated sensors among sensors distributed along a pipeline network, the computer program product comprising a computer readable storage medium having program instructions embodied therewith, the program instructions executable by a processor to perform a method comprising:
designating a set of the sensors as upstream sensors based on their geopositions;
designating remaining ones of the sensors other than the set of the sensors as downstream sensors;
determining a temporal delay associated with each of the sensors; and
calibrating the uncalibrated sensors based on the corresponding temporal delay and on calibrated sensors among the sensors.

16. The computer program product according to claim 15, further comprising obtaining a time-varying signal from each of the sensors.

17. The computer program product according to claim 16, wherein the determining the temporal delay includes isolating a subset of the time-varying signal associated with each of the sensors such that a duration of every subset is the same and a start time and an end time of every subset is determined for each of the sensors.

18. The computer program product according to claim 16, wherein the determining the temporal delay includes solving an equation representing mass conservation law that is given by:

|Σ_{iεU} Σₜ_{ₛₜᵣₜ}_{+Δt}_{ᵢ}^{t}^{_{end}}^{+Δt}^{ᵢ}Qᵢ(t)−Σ_{iεD} Σₜ_{ₛₜᵣₜ}_{+Δt}_{ᵢ}^{t}^{_{end}}^{+Δt}^{ᵢ}Qᵢ(t)|ₙₒᵣₘ, where
U refers to the upstream sensors, D refers to the downstream sensors, tstrt and tend are start and end times, respectively, that are fixed for all the sensors, Δt is the temporal delay associated with each of the sensors, and Q(t) is iso-thermal mass flow rate obtained from the time-varying signal of each of the sensors, and determining the Δt for each of the sensors that makes a result of the equation less than a threshold value.

19. The computer program product according to claim 18, further comprising determining the iso-thermal mass flow rate for each of the sensors as:
Qᵢ(t)=pᵢ(t)qᵢ(t), where
p(t)=1 and q(t) is flow rate indicated by the time-varying signal based on the pipeline network transporting water, and determining the iso-thermal mass flow rate for each of the sensors as:
Qᵢ(t)=pᵢ(t)(pᵤₚₛₜᵣₑₐₘ−pᵢ(t)), where
p(t)=is pressure indicated by the time-varying signal based on the pipeline network transporting natural gas, and pᵤₚₛₜᵣₑₐₘ is an upstream pressure value determined based on monitoring the sensors.

20. The computer program product according to claim 19, wherein the calibrating the uncalibrated sensors includes obtaining measured values of pressure \hat{p} and flow rate \hat{q} from the time-varying signal from each of the sensors and determining coefficients α, β, a, and b for each of the uncalibrated sensors that minimize the equation, given that:
qᵢ=αᵢ\hat{q}ᵢ+βᵢ, and
pᵢ=aᵢ\hat{p}ᵢ+bᵢ.
